(19) United States
(12) Patent Application Publication
(10) Pub. No.: US 2019/0385466 A1
(43) Pub. Date: Dec. 19, 2019

(54) AIRCRAFT PERFORMANCE BASED COLLISION AVOIDANCE

(71) Applicant: GE Aviation Systems LLC, Grand Rapids, MI (US)

(72) Inventors: Edward Parker, Cheltenham (GB); Stefan Alexander Schwindt, Cheltenham (GB)

(21) Appl. No.: 16/007,450

(22) Filed: Jun. 13, 2018

(51) Int. Cl. G08G 5/04; G08G 5/00

(52) U.S. Cl. CPC G08G 5/045; G08G 5/0039; G08G 5/0008

(57) ABSTRACT

Systems, computer-implemented methods and/or computer program products that facilitate generating aircraft performance volume based on collision avoidance are provided. In one embodiment, a system utilizes a processor that executes computer implemented components stored in a memory. A graph component uses flight management data to plot course of flight for a determined period of time. A deviation component calculates a volume of space of aircraft performance that is capable of deviating from the course of flight based on current aircraft configuration and capability. A search component searches for intersections between the volume of space of the aircraft with broadcasted volume of space of other aircrafts to identify potential collisions.

### TECHNICAL FIELD

The subject disclosure relates to facilitating generating aircraft performance volume based on collision avoidance.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments herein, devices, systems, computer-implemented methods, apparatus and/or computer program products that facilitate generating aircraft performance volume based on collision avoidance are described.

According to one embodiment, a system is provided. The system can comprise a memory that stores computer executable components. The system can also comprise a processor, operably coupled to the memory, and that can execute computer executable components stored in the memory. The computer executable components can comprise a graph component that uses flight management data to plot course of flight for a determined period of time. The computer executable components can further comprise a deviation component that calculates a volume of space of aircraft performance that is capable of deviating from the course of flight based on current aircraft configuration and capability. The computer executable components can further comprise a search component that searches for intersections between the volume of space of the aircraft with broadcasted volume of space of other aircrafts to identify potential collisions.

According to another embodiment, a computer-implemented method is provided. The computer-implemented method can comprise using, by a system operatively coupled to a processor, flight management data to plot course of flight for a determined period of time. The computer-implemented method can further comprise calculating, by the system, a volume of space of aircraft performance that is capable of deviating from the course of flight based on current aircraft configuration and capability. The computer-implemented method can further comprise searching, by the system, for intersections between the volume of space of the aircraft with broadcasted volume of space of other aircrafts to identify potential collisions.

According to another embodiment, a computer program product facilitating generating aircraft performance volume based on collision avoidance is provided. The computer program product can comprise a computer readable storage medium having program instructions embodied therewith. The program instructions can be executable by a processor to cause the processor to use flight management data to plot course of flight for a determined period of time. The program instructions can further be executable by a processor to cause the processor to calculate a volume of space of aircraft performance that is capable of deviating from the course of flight based on current aircraft configuration and capability. The program instructions can further be executable by a processor to cause the processor to search for intersections between the volume of space of the aircraft with broadcasted volume of space of other aircrafts to identify potential collisions

### DESCRIPTION OF THE DRAWINGS

FIG. 1 illustrates a block diagram of an example, non-limiting system facilitating generating aircraft performance volume based on collision avoidance in accordance with one or more embodiments described herein.

FIG. 2 illustrates a block diagram of an example, non-limiting system facilitating generating aircraft performance volume based on collision avoidance including a broadcast component in accordance with one or more embodiments described herein.

FIG. 3 illustrates a block diagram of an example, non-limiting system facilitating generating aircraft performance volume based on collision avoidance including a recreation component in accordance with one or more embodiments described herein.

FIG. 4 illustrates a block diagram of an example, non-limiting system facilitating generating aircraft performance volume based on collision avoidance including a negotiation component in accordance with one or more embodiments described herein.

FIG. 5 illustrates diagrams of an example, non-limiting volumes of space of aircraft performance in accordance with one or more embodiments described herein.

FIGS. 6-9 illustrate block diagrams of example, non-limiting computer-implemented methods facilitating generating aircraft performance volume based on collision avoidance in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

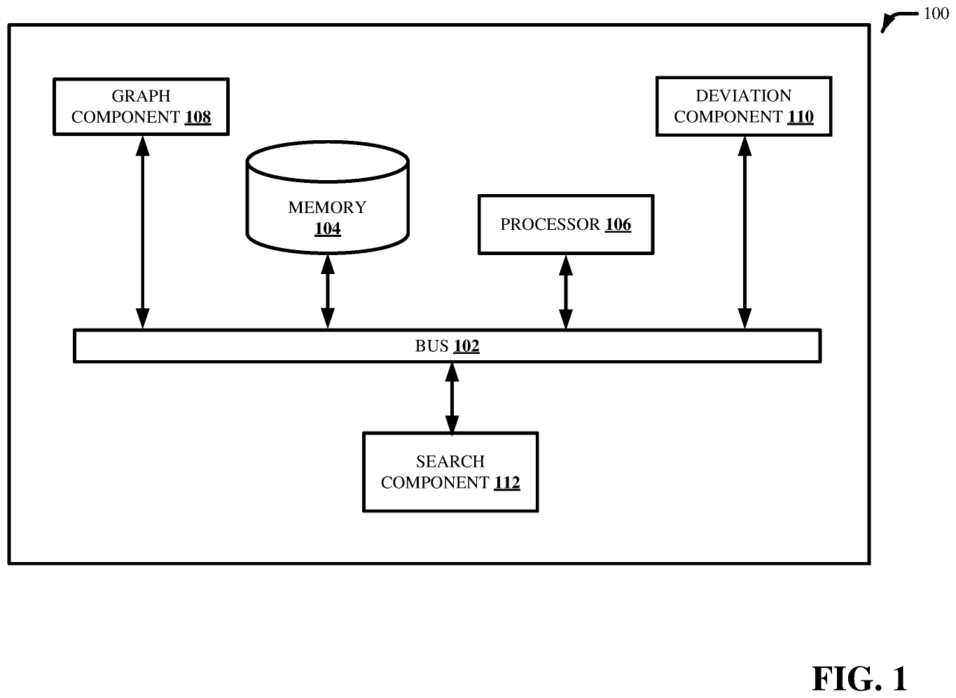

One or more embodiments described herein can facilitate generating aircraft performance volume based on collision avoidance. The term “aircraft” or “aircrafts” can mean all types of aircraft including fixed-wing, rotorcraft, lighter-than-air, manned aircraft or unmanned aerial vehicle (UAV). More specifically, one or more embodiments herein can generate a resolution advisory that can negotiate for maximum clear space while considering aircraft configuration and capability. One or more embodiments herein can calculate a volume of space in a four-dimensional (4D) to consider agility in vertical movements, lateral movements and time as different aircrafts can have different capabilities. In order to minimize the number of parameters being broadcasted, one or more embodiments herein can receive and recreate a volume of space for other aircrafts. Volume of spaces between respective aircrafts can be used to search for intersections (e.g., overlaps between volume of spaces indicating potential collisions) and negotiate a resolution advisory between the respective aircrafts. FIG. 1 illustrates a block diagram of an example, non-limiting system 100 generating aircraft performance volume based on collision in accordance with one or more embodiments described herein. Aspects of systems (e.g., system 100 and the like), apparatuses or processes explained in this disclosure can constitute one or more machine-executable components embodied within one or more machines, e.g., embodied in one or more computer readable mediums (or media) associated with one or more machines. Such components, when executed by the one or more machines, e.g., computers, computing devices, etc., can cause the machines to perform the operations described. In various embodiments, the system 100 can be any type of component, machine, device, facility, apparatus, and/or instrument that comprises a processor. In some embodiments, system 100 is capable of effective and/or operative communication with a wired and/or wireless network.

As illustrated in FIG. 1, system 100 can comprise bus 102, memory 104, processor 106, graph component 108, deviation component 110 and/or search component 112. Bus 102 can provide for interconnection of various components of system 100. Memory 104 and processor 106 can carry out computation and/or storage operations of system 100 as described herein. It is to be appreciated that in some embodiments one or more system components can communicate wirelessly with other components, through a direct wired connection or integrated on a chipset.

In various embodiments, graph component 108 can use flight management data to plot course of flight for a determined period of time. A course of flight can be a direction in which an aircraft anticipates flying. For example, graph component 108 can plot course of flight an aircraft anticipates flying within 5 minutes, within 10 minutes, etc. Information pertaining to course of flight can be part of a flight management data. In addition, flight management data can also include most extreme flight profile possible such as maximum climb, descent and turn achievable with changing thrust, flaps or other settings within allowable limits. An aircraft can have a maximum climb or maximum climb rate that can be achievable. A maximum climb rate can determine a speed at which an aircraft climb or move in a vertical direction. Different types of aircrafts can have different maximum climb rates until it reaches a service ceiling at which point the aircraft cannot fly any higher. In addition, climb rates can also be a function of other parameters, e.g., current altitude. Similarly, different types of aircrafts can turn or change lateral direction left or right at different rates. One or more embodiments described herein can also consider aircraft configuration or capability. Different aircrafts can have different agility or speed in changing direction which can also be dependent on current aircraft configuration. An aircraft configuration can be air surface control settings, engine settings, etc.

Furthermore, flight management data can also include data from terrain warning data. Terrain warning data can include geographic data of location of mountains, trees, buildings, towers, etc. Terrain warning data can be considered in generating an aircraft performance volume to avoid collisions. For example, an aircraft performance volume can exclude areas with mountains so an aircraft does not have a descend command into a mountain.

Aircraft configuration or capability can be used to generate a 4D volume of space along a course of flight plotted by graph component 108. Deviation component 110 can calculate a volume of space of aircraft performance that is capable of deviating from the course of flight based on current aircraft configuration and capability. A volume of space of aircraft performance can consists of performances that an aircraft is capable of performing. A performance that an aircraft is capable of performing should not overstress the airframe. An aircraft's performance capabilities can depend not only on the type of aircraft but also its current configurations such as whether its flaps are up or down because moving the moving the flaps can take a long time. An aircraft may not be able to deflect or move its flaps within a reasonable time to affect a resolution advisory between aircrafts that are approaching each other. For example, turbofan aircrafts may not be able to significant change in thrust in a short amount of time. Whereas propeller aircrafts may be able to respond more quickly with changes in thrust.

An aircraft performance can also be dependent on its altitude, engine power, etc. Some aircrafts can have a lot of climb performance and some do not. For an aircraft that can move in every direction equally well, its volume of space can be a cone. Graph component 108 can plot a course of flight which can be a line direction along which an aircraft anticipates flying. Deviation component 110 can calculate a volume of space around that course of flight. An aircraft that can move in every direction equally well can have a volume that resembles a circle. An aircraft that can move equally well in every direction can move left or right at the same speed as it can climb or descend. As time goes on, the aircraft can move further and further apart increasing the size of the circle. Therefore, along a course of flight for a determined amount of time, a volume of space for an aircraft that can move equally well in every direction can be a cone.

Some aircrafts can descend faster than they can climb or move left or right thereby resulting in a more complex shape than a cone. Especially, as an aircraft reaches its service ceiling, there can be less and less room for it to climb into. Changing direction left or right can take more time than descending. A real shape of a volume of space can have a large area an aircraft can descend, a smaller area side to side and a slightly higher area on top. For simplicity, a cone can be generated based on conservative values of an aircraft's worst performance However, a volume of space can range from cones to Non-Uniform Rational B-Spline (NURBS), splines or Bezier surfaces.

A volume of space for an aircraft can be used to identify areas of potential collisions among aircrafts within a vicinity. Search component 112 can search for intersections between a volume of space of an aircraft with a broadcasted volume of space of other aircrafts to identify potential collisions. A volume of space can be generated based on an aircraft's speed to truly determine whether two aircrafts will come close to one another. It could be that one aircraft is flying so slowly that it is not going to get close to the other aircraft. More specifically, a volume of space can be a 4D trajectory used to determine whether there is going to be an intersection or collision in time and space.

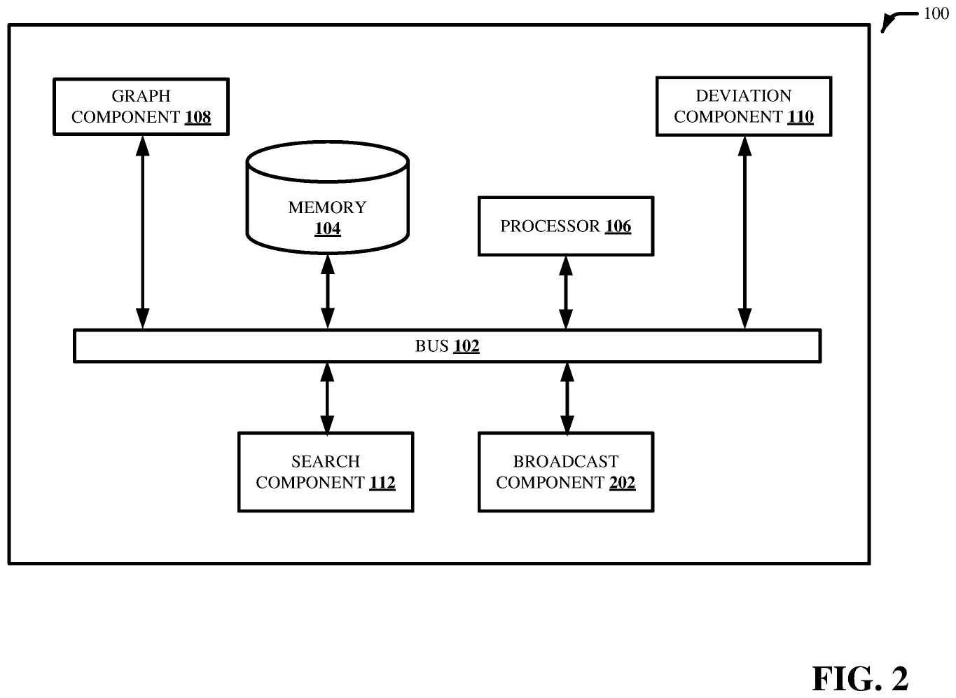

An aircraft's volume of space can be calculated by the deviation component 110 based on its flight management data. Other aircrafts volume of space can be generated based on parameters of volume of space calculated by the other aircrafts. FIG. 2 illustrates a block diagram of an example, non-limiting system 100 facilitating generating aircraft performance volume based on collision avoidance including a broadcast component 202 in accordance with one or more embodiments described herein. Repetitive description of like elements employed in other embodiments described herein is omitted for sake of brevity. Broadcast component 202 can broadcast parameters of volume of space. Aircrafts can calculate (e.g., via deviation component 110) a volume of space and broadcast (e.g., via broadcast component 202) parameters of that volume of space to other aircrafts within a vicinity. By broadcasting parameters of volume of space an aircraft can move into, the amount of data needed to determine another aircraft's performance based on its configuration and capability can be minimized A volume of space generated (e.g., via deviation component 110) can capture an aircraft's performance while considering its configuration and capability. Cone shaped volume of space can be broadcasted by broadcast component 202 using two parameters, which can be the height and radius. More complex shapes can have more number of parameters. Aviation industry can standardize the shape and number of parameters being broadcasted.

As an aircraft changes its configuration, its volume of space can also change. For example, if an aircraft decreases drag by lowering the deflection of its flaps, the aircraft can move faster thereby increasing its volume of space. Therefore, broadcast component 202 can also broadcast updates to the volume of space. Aviation industry can also standardize how often broadcast component 202 need to broadcast updates.

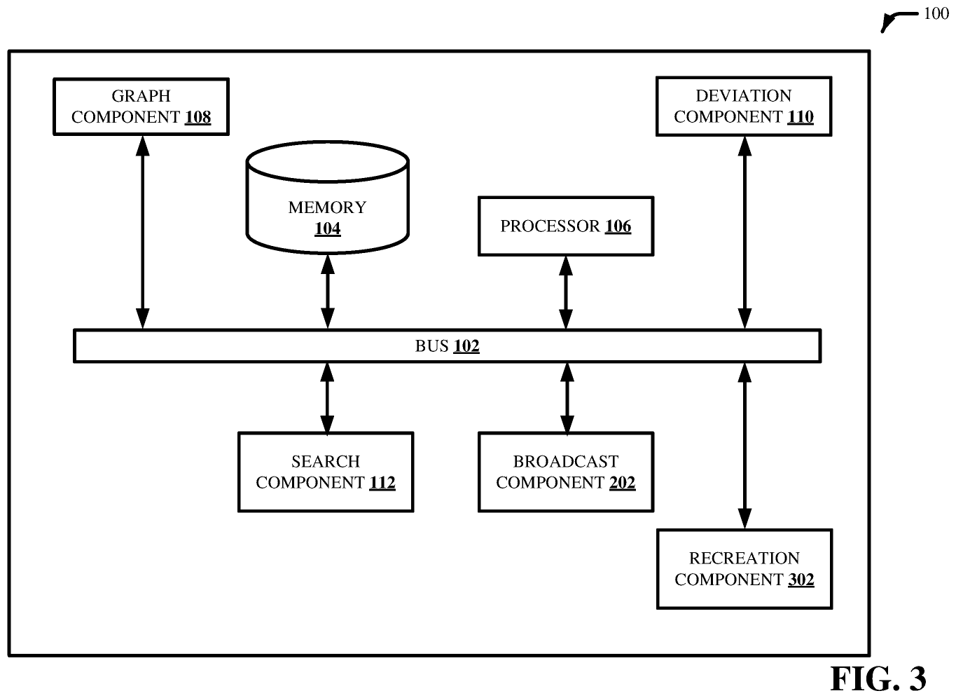

Parameters of volume of space can be broadcasted (e.g., via broadcast component 202) to other aircrafts so those aircrafts can recreate (e.g., via recreation component 302) the other aircraft's volume of space to determine (e.g., via search component 112) areas of intersections between the volume of spaces that would cause a collision. FIG. 3 illustrates a block diagram of an example, non-limiting system 100 facilitating generating aircraft performance volume based on collision avoidance including a recreation component 302 in accordance with one or more embodiments described herein. Repetitive description of like elements employed in other embodiments described herein is omitted for sake of brevity. Recreation component 302 can recreate a volume of space of other aircrafts based on parameters broadcasted by the other aircrafts. Recreation component 302 can receive parameters of volume of space broadcasted by broadcast component 202 of other aircrafts and use those parameters to recreate a volume of space.

For example, if recreation component 302 receives a height and radius of a cone as a volume of space of an aircraft, the recreation component 302 can recreate that cone. A height of a cone can include an aircraft's current trajectory or course of flight that can include the direction in which the aircraft is flying. A radius of a cone can be a maximum space that an aircraft can move into based on its capabilities. A high-performance aircraft can have a wider cone and a low-performance aircraft can have a narrower cone around its trajectory.

Search component 112 can use the volume of spaces calculated (e.g., via deviation component 110) and recreated (e.g., via recreation component 302) to search for intersections between the volume of space to predict areas of potential collisions that can be avoided. Volume of spaces can include an aircraft's current trajectory or course of flight, which search component 112 can use to place the volume of spaces relative to one another. Search component 112 can search for areas that overlap between the volume of spaces. Overlapping areas between the volume of spaces can be used as a prediction for potential collision.

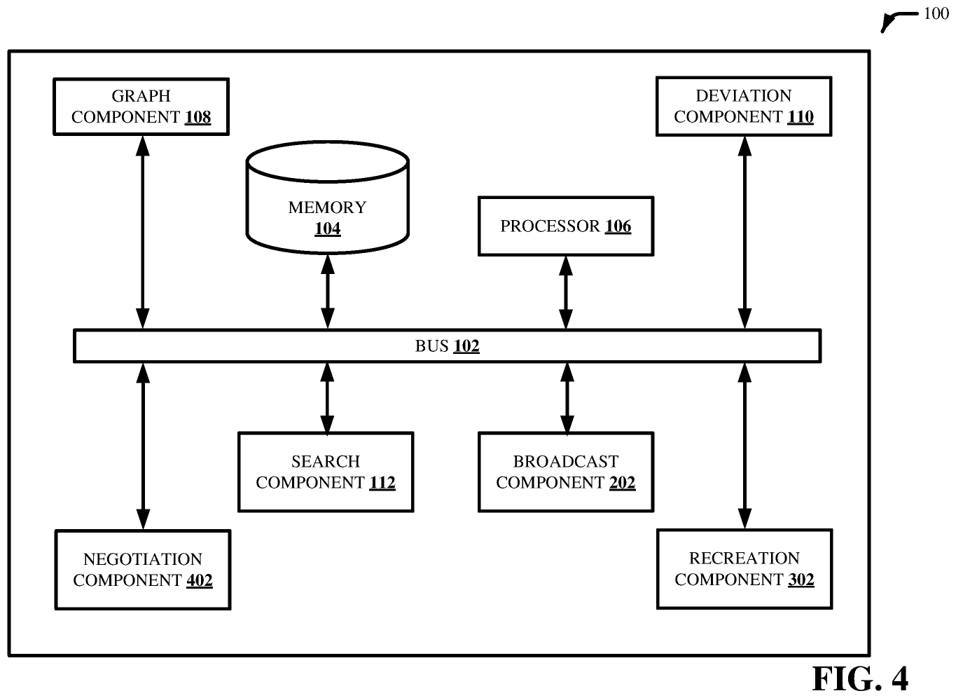

Aircrafts that are found (e.g., via search component 112) to have overlapping volume of spaces can negotiate (e.g., via negotiation component 402) for a resolution advisory providing maximum clear space the aircrafts can move into considering their configuration and capability. FIG. 4 illustrates a block diagram of an example, non-limiting system 100 facilitating generating aircraft performance volume based on collision avoidance including a negotiation component 402 in accordance with one or more embodiments described herein. Repetitive description of like elements employed in other embodiments described herein is omitted for sake of brevity. Negotiation component 402 can negotiate a resolution between intersecting volume of spaces by moving respective aircrafts into areas of maximum clear space. A maximum clear space can be an area away from an overlapping area of potential collision so that if an aircraft does go into an overlapping area, the other aircraft can avoid risks of being too close. Broadcasting aircrafts and receiving aircrafts should have the same parameters of the volume of spaces, so search component 112 for respective aircrafts should come find the same intersections or overlaps between the volumes of spaces. Likewise, negotiation component 402 for respective aircrafts should also come to the same conclusion for resolution advisories for the respective aircrafts. For example, two negotiating aircrafts should agree which aircraft should maneuver where based on direction of maximum free space.

Negotiation component 402 can also negotiate a resolution advisory with a performance volume by removing from a volume of space areas of potential collisions, areas of performance not capable of achieving or areas of known traffic. For example, negotiation component 402 can incorporate known traffic or collision course with other aircrafts in negotiating a resolution advisory with a performance volume that can be performed based on an aircraft's configuration or capability. Similarly, negotiation component 402 can incorporate flight management data during negotiation of a resolution advisory. For example, negotiation component 402 can use terrain warning data to remove areas with towers from a volume of space so that a resolution advisory does not include those areas.

In addition, negotiation component 402 can identify stationary aircrafts on ground based on its broadcasted volume of space so as to not cause a resolution advisory with those stationary aircrafts. Furthermore, negotiation component 402 can recognize an aircraft is landing based on its performance model from its broadcasted volume of space. If an aircraft is flying over an airport and recognizing that another aircraft coming towards it is landing, it does not negotiate a resolution advisory with that other aircraft.

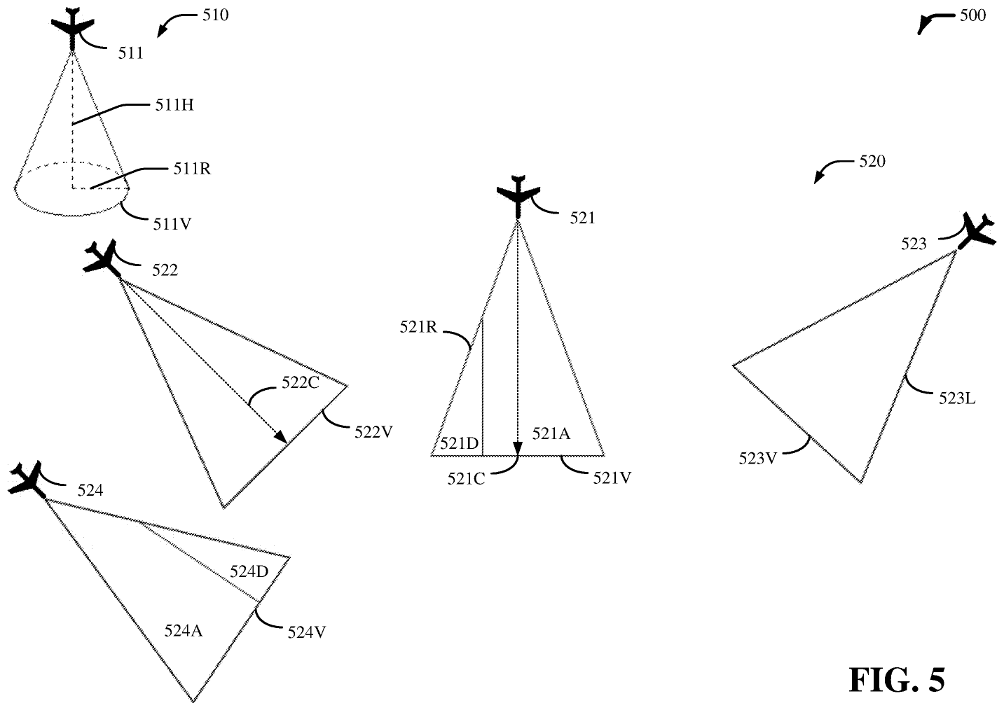

FIG. 5 illustrates diagrams 500 of an example, non-limiting volumes of space of aircraft performance in accordance with one or more embodiments described herein. Repetitive description of like elements employed in other embodiments described herein is omitted for sake of brevity. Diagram 510 depicts aircraft 511 projecting volume of space 511V of its capability based on its current configuration. Volume of space 511 describes that with aircraft 511's current configuration, it can deviate from its current position within the space of the volume of space 511V. In reality, some aircrafts can descend better than it can climb or turn (e.g., move left or right), so a realistic shape may not be as symmetrical as a cone. The radius of the cone can be based on an aircraft's most limiting movement. It is appreciated that more complex shapes such as NURBS, splines or Bezier surfaces can also be used. Based on aircraft 511's current configuration (e.g., flight control surface deflection, engine setting, attitude, altitude, etc.), volume of space 511V can show that for a given amount of time, aircraft 511 can fly a distance represented by height 511H of the cone or volume of space 511V. Height 511H can also describe the trajectory or direction in which aircraft 511 is flying. Aircraft 511 can climb, descend and turn at distance of radius 511R. As time passes, aircraft 511 can fly further and further, thus, increasing its height 511H and radius 511R.

Aircraft 511 can broadcast its parameters or height 511H and radius 511R to another aircraft (not shown) of incoming traffic. Both aircraft 511 and another approaching aircraft (not shown) can broadcast (e.g., via broadcast component 202) its parameters (e.g., height 511H and radius 511R) to one another and recreate (e.g., via recreation component 302) the other's volume of space. The aircrafts can search (e.g., via search component 112) for intersection within one another's volumes of space and negotiate (e.g., via negotiation component 402) a resolution that is based on the aircrafts' current configurations and capabilities. It is appreciated that the number of parameters (e.g., shape complexity) and amount of time (e.g., affects size of volume of space) can be standardized within the industry.

Diagram 520 depicts aircrafts 521, 522, 523 and 524 projecting cone shaped volumes of space 52W, 522V, 523V and 524V, respectively. As aircraft 521 and 522 approach one another, the aircrafts can broadcast (e.g., via broadcast component 202) its parameters such as height and radius (not shown) of its cone shaped volumes of space 521V and 522V. The aircrafts 521 and 522 can recreate (e.g., via recreation component 302) the other's volume of space and search (e.g., via search component 112) for intersections. Volume of space 522V can be projected to intersect volume of space 521V within volume 521D. The aircrafts 521 and 522 can negotiate (e.g., via negotiation component 402) that aircraft 521 disallow performance in within volume 521D and allow performance within volume 521A avoiding being too close to volume 521D to be within area of maximum clear space. Although aircraft 521 is capable of flying within volume 521D, aircraft 521 is going to disallow performance within volume 521D because if it has to do a resolution advisory with another aircraft, that can cause a conflict with aircraft 522 if the resolution is to fly within volume 521D.

As aircraft 523 approaches, aircraft 521 can broadcast its volume of space 521V and indicate that it is not allowed to fly within volume 521D. Aircraft 521 can use angles to describe volume of space 521D. If straightforward down the center 521C of volume 521V is zero degrees, aircraft 521 can broadcast that a certain degree towards side 521R is where its performance is disallowed. Aircraft 523 can recognize that aircraft 521 will have to fly within volume 521A, and the aircrafts 521 and 523 can negotiate that aircraft 523 fly closer to side 523L or climb or descend to avoid a collision with aircraft 521.

Although aircrafts 521 and 522 negotiated that aircraft 521D disallows performance within volume 521D, aircraft 522 should also avoid intersecting volume 521D because in case aircraft 521 decides to perform within volume 521D, that could cause a collision. Aircraft 522 can negotiate with aircraft 524 that aircraft 522 fly somewhere towards center 522C (e.g., to be within area of maximum clear space) and aircraft 524 disallow performance within intersecting volume 524D while allowing performance within volume 524A. In this way, the aircrafts 521, 522, 523 and 524 are all flying within area of maximum clear space and not create a cascading effect of negotiating avoidance of collision. For example, a cascading effect could be that while aircraft 522 negotiate to avoid a collision with aircraft 521, aircraft 522 is flying into volume of space 524V of aircraft 524 at intersecting volume 524D, and so on.

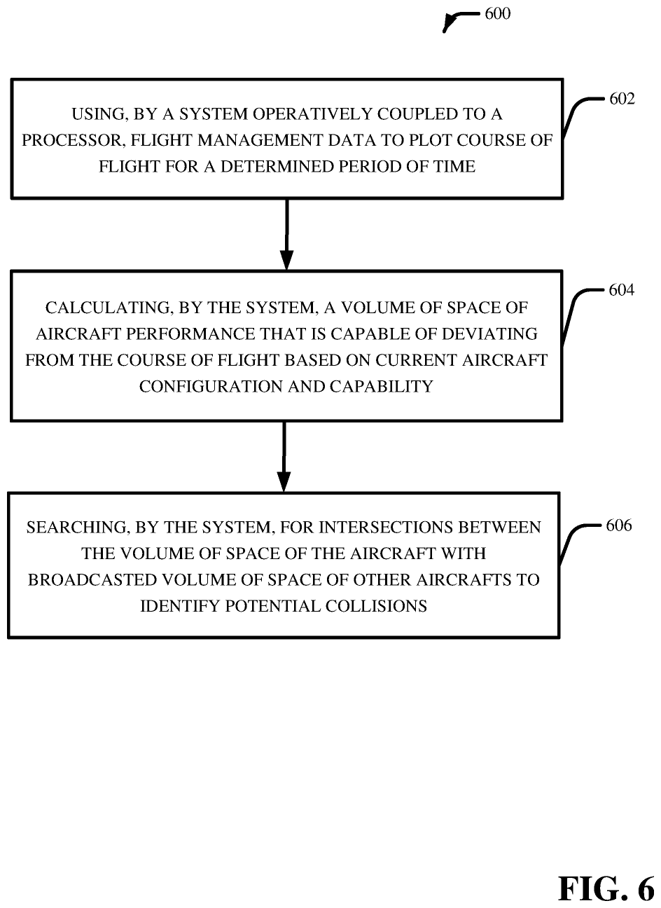

FIG. 6 illustrates a block diagram of example, non-limiting computer-implemented method 600 facilitating generating aircraft performance volume based on collision avoidance in accordance with one or more embodiments described herein. Repetitive description of like elements employed in other embodiments described herein is omitted for sake of brevity. At 602, the computer-implemented method 600 can comprise using (e.g., via graph component 108), by a system operatively coupled to a processor, flight management data to plot course of flight for a determined period of time. At 604, the computer-implemented method 600 can comprise calculating (e.g., via deviation component 110), by the system, a volume of space of aircraft performance that is capable of deviating from the course of flight based on current aircraft configuration and capability. At 606 (e.g., via search component 112), the computer-implemented method 600 can comprise searching, by the system, for intersections between the volume of space of the aircraft with broadcasted volume of space of other aircrafts to identify potential collisions.

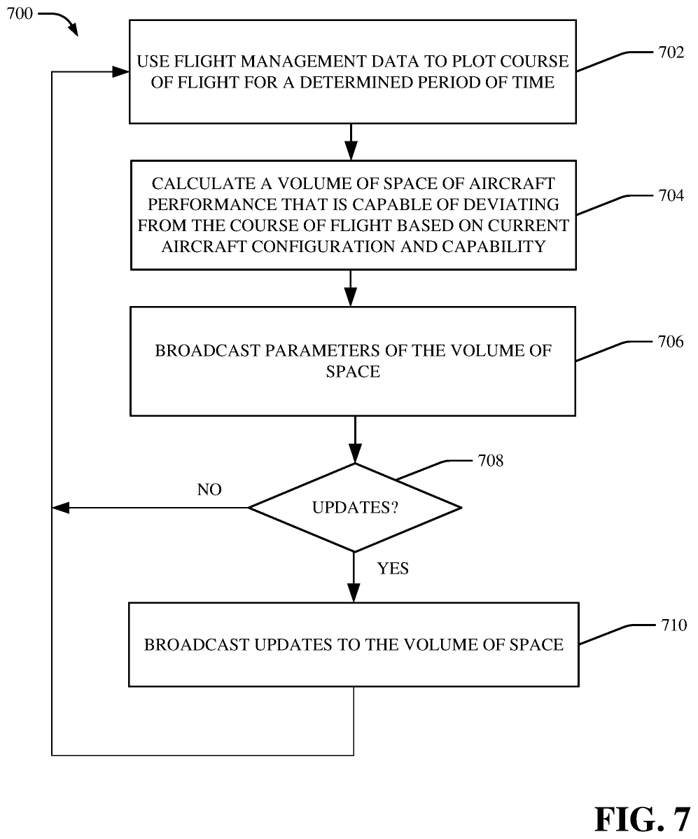

FIG. 7 illustrates a block diagram of example, non-limiting computer-implemented method 700 facilitating generating aircraft performance volume based on collision avoidance in accordance with one or more embodiments described herein. Repetitive description of like elements employed in other embodiments described herein is omitted for sake of brevity. At 702, the computer-implemented method 700 can comprise using (e.g., via graph component 108) flight management data to plot course of flight for a determined period of time. At 704, the computer-implemented method 700 can comprise calculating (e.g., via deviation component 110) a volume of space of aircraft performance that is capable of deviating from the course of flight based on current aircraft configuration and capability. At 706, the computer-implemented method 700 can comprise broadcasting (e.g., via broadcast component 202) parameters of the volume of space. At 708, the computer-implemented method 700 can comprise determining (e.g., via broadcast component 202) whether the volume of space has updates or has changed. If no, the process returns to 702. If yes, the process proceeds to 710. At 710, the computer-implemented method 700 can comprise broadcasting updates to the volume of space.

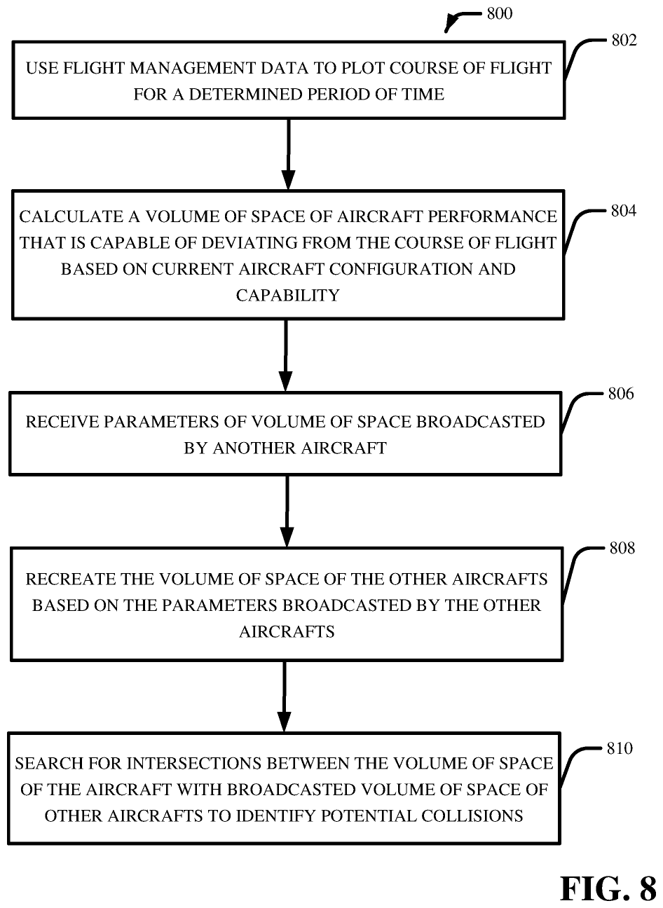

FIG. 8 illustrates a block diagram of example, non-limiting computer-implemented method 800 facilitating generating aircraft performance volume based on collision avoidance in accordance with one or more embodiments described herein. Repetitive description of like elements employed in other embodiments described herein is omitted for sake of brevity. At 802, the computer-implemented method 800 can comprise using (e.g., via graph component 108) flight management data to plot course of flight for a determined period of time. At 804, the computer-implemented method 800 can comprise calculating (e.g., via deviation component 110) a volume of space of aircraft performance that is capable of deviating from the course of flight based on current aircraft configuration and capability. At 806, the computer-implemented method 800 can comprise receiving (e.g., via recreation component 302) parameters of volume of space broadcasted by another aircraft. At 808, the computer-implemented method 800 can comprise recreating (e.g., via recreation component 302) the volume of space of the other aircrafts based on the parameters broadcasted by the other aircrafts. At 810, the computer-implemented method 800 can comprise searching (e.g., via search component 112) for intersections between the volume of space of the aircraft with broadcasted volume of space of other aircrafts to identify potential collisions.

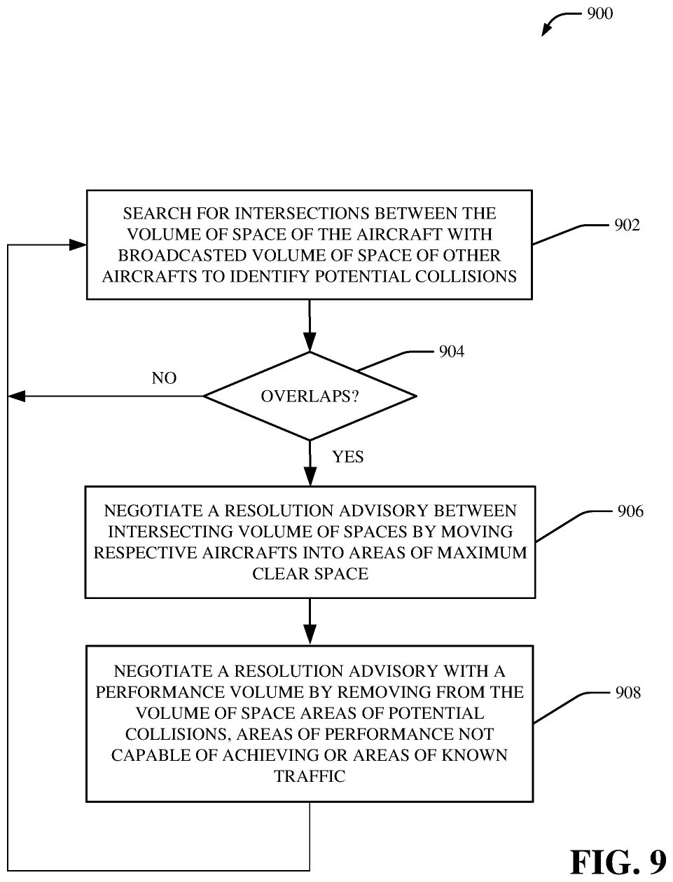

FIG. 9 illustrates a block diagram of example, non-limiting computer-implemented method 900 facilitating generating aircraft performance volume based on collision avoidance in accordance with one or more embodiments described herein. Repetitive description of like elements employed in other embodiments described herein is omitted for sake of brevity. At 902, the computer-implemented method 900 can comprise searching (e.g., via search component 112) for intersections between the volume of space of the aircraft with broadcasted volume of space of other aircrafts to identify potential collisions. At 904, the computer-implemented method 900 can comprise determining (e.g., via search component 112) whether there are overlaps between the volume of spaces. If no, the process returns to 902. If yes, the process proceeds to 906. At 906, the computer-implemented method 900 can comprise negotiating (e.g., via negotiation component 402) a resolution advisory between intersecting volume of spaces by moving respective aircrafts into areas of maximum clear space. At 908, the computer-implemented method 900 can comprise negotiating (e.g., negotiation component 402) a resolution advisory with a performance volume by removing from the volume of space areas of potential collisions, areas of performance not capable of achieving or areas of known traffic.

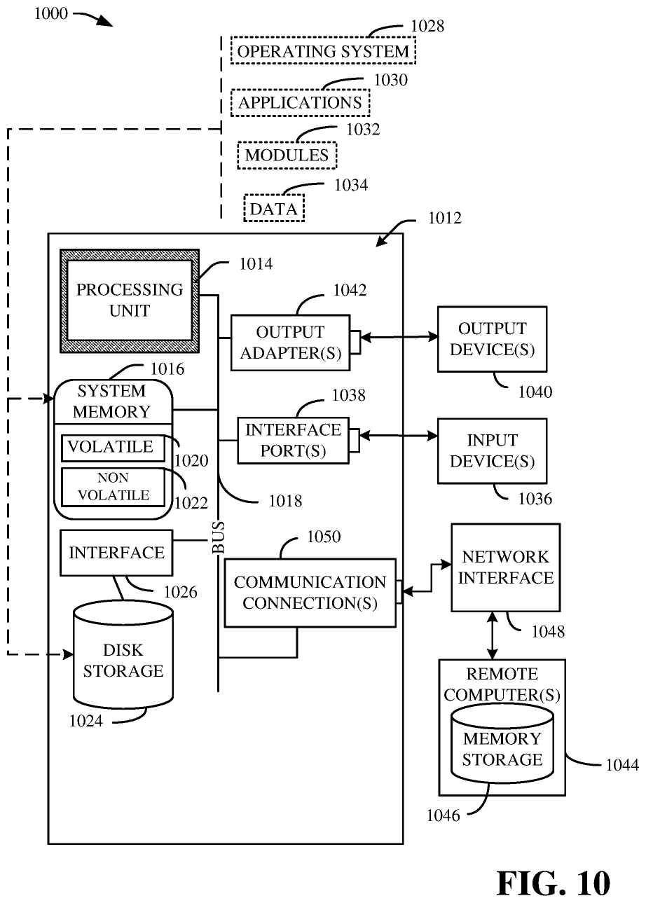

To provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, a suitable operating environment 1000 for implementing various aspects of this disclosure can also include a computer 1012. The computer 1012 can also include a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1016 can also include volatile memory 1020 and nonvolatile memory 1022. The basic input/output system (BIOS), containing the basic routines to transfer information between elements within the computer 1012, such as during start-up, is stored in nonvolatile memory 1022. Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media. To facilitate connection of the disk storage 1024 to the system bus 1018, a removable or non-removable interface is typically used, such as interface 1026. FIG. 10 also depicts software that acts as an intermediary between users and the basic computer resources described in the suitable operating environment 1000. Such software can also include, for example, an operating system 1028. Operating system 1028, which can be stored on disk storage 1024, acts to control and allocate resources of the computer 1012.

System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port can be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc., that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes computer executable components stored in the memory, wherein the computer executable components comprise:
a graph component that uses flight management data to plot course of flight for a determined period of time;
a deviation component that calculates a volume of space of aircraft performance that is capable of deviating from the course of flight based on current aircraft configuration and capability; and
a search component that searches for intersections between the volume of space of the aircraft with broadcasted volume of space of other aircrafts to identify potential collisions.

2. The system of claim 1, further comprising a broadcast component that broadcasts parameters of the volume of space.

3. The system of claim 2, further comprising a recreation component that recreates the volume of space of the other aircrafts based on the parameters broadcasted by the other aircrafts.

4. The system of claim 1, further comprising a negotiation component that negotiates a resolution advisory between intersecting volume of spaces by moving respective aircrafts into areas of maximum clear space.

5. The system of claim 1, wherein the volume of space ranges from cones to Non-Uniform Rational B-Spline (NURBS), splines or Bezier surfaces.

6. The system of claim 1, wherein the flight management data include most extreme flight profile possible such as maximum climb, descent and turn achievable with charging thrust, flaps or other settings within allowable limits.

7. The system of claim 1, wherein the flight management data also include terrain warning data.

8. The system of claim 4, wherein the negotiation component also negotiates a resolution advisory with a performance volume by removing from the volume of space areas of potential collisions, areas of performance not capable of achieving or areas of known traffic.

9. The system of claim 2, wherein the broadcast component also broadcasts updates to the volume of space.

10. A computer-implemented method, comprising:
using, by a system operatively coupled to a processor, flight management data to plot course of flight for a determined period of time;
calculating, by the system, a volume of space of aircraft performance that is capable of deviating from the course of flight based on current aircraft configuration and capability; and
searching, by the system, for intersections between the volume of space of the aircraft with broadcasted volume of space of other aircrafts to identify potential collisions.

11. The system of claim 10, further comprising broadcasting parameters of the volume of space.

12. The system of claim 11, further comprising recreating the volume of space of the other aircrafts based on the parameters broadcasted by the other aircrafts.

13. The system of claim 10, further comprising negotiating a resolution advisory between intersecting volume of spaces by moving respective aircrafts into areas of maximum clear space.

14. The system of claim 13, wherein the negotiating a resolution advisory between intersecting volume of spaces comprises negotiating the resolution advisory with a performance volume by removing from the volume of space areas of potential collisions, areas of performance not capable of achieving or areas of known traffic.

15. The system of claim 11, wherein the broadcasting parameters of the volume of space comprises broadcasting updates to the volume of space.

16. A computer program product for facilitating generating aircraft performance volume based on collision avoidance, the computer program product comprising a computer readable storage medium having program instructions embodied therewith, the program instructions executable by a processor to cause the processor to:
use flight management data to plot course of flight for a determined period of time;
calculate a volume of space of aircraft performance that is capable of deviating from the course of flight based on current aircraft configuration and capability; and
search for intersections between the volume of space of the aircraft with broadcasted volume of space of other aircrafts to identify potential collisions.

17. The computer program product of claim 16, wherein the program instructions are further executable to cause the processor to:
broadcast parameters of the volume of space.

18. The computer program product of claim 17, wherein the program instructions are further executable to cause the processor to:
recreate the volume of space of the other aircrafts based on the parameters broadcasted by the other aircrafts.

19. The computer program product of claim 16, wherein the program instructions are further executable to cause the processor to:
negotiate a resolution advisory between intersecting volume of spaces by moving respective aircrafts into areas of maximum clear space.

20. The computer program product of claim 16, wherein the program instructions are further executable to cause the processor to:
negotiate the resolution advisory with a performance volume by removing from the volume of space areas of potential collisions, areas of performance not capable of achieving or areas of known traffic.
